(19) United States
(12) Patent Application Publication
(10) Pub. No.: US 2009/0229390 A1
(43) Pub. Date: Sep. 17, 2009

(54) LOCKING AND UNLOCKING DEVICE

(75) Inventor: Ton Ickenroth, Heythuysen (NL)

Correspondence Address: Johnson Controls, Inc.;c/o Fletcher Yoder PC, P.O. Box 692289, Houston, TX, 77269, US

(73) Assignee: Johnson Control Technology Company, Holland, MI (US)

(21) Appl. No.: 12/389,237

(22) Filed: Feb. 19, 2009

(30) Foreign Application Priority Data
Aug. 21, 2006 (DE) 10 2006038 988.3
Aug. 15, 2007 (EP) PCT/EP2007/007199

(51) Int. Cl. F16H 21/44

(52) U.S. Cl. 74/110

(57) ABSTRACT

A locking and unlocking device includes a displaceably mounted locking element and an actuating element that actuates the locking element. A deformation element is deformed when the actuating element is actuated, thus displacing the locking element. The deformation element may be a spring, such as a leaf or leg spring.

### CROSS REFERENCE TO RELATED APPLICATIONS

This application claims priority from and the benefit of PCT Application No PCT/EP2007/007199, filed on Aug. 15, 2007; and German Patent No. DE 10 2006 038 988.3, filed on Aug. 21, 2006, both entitled “Locking and Unlocking Device ”, which are hereby incorporated by reference.

### BACKGROUND

The present invention relates to a locking and unlocking device comprising at least one displaceably mounted locking element and an actuating element which actuates the locking element.

Generic locking and unlocking devices are known from the prior art, for example from EP 1 538 288 and DE 41 39 740 C1. The mechanisms disclosed there are, however, relatively complicated and have a large number of parts and are accordingly costly to produce.

It was, therefore, the object of the present invention to provide a locking and unlocking device which does not have the drawbacks of the prior art.

### SUMMARY

The object is achieved by a locking and unlocking device comprising at least one displaceably mounted locking element and an actuating element, which actuates the locking element, comprising a deformation element which, when actuating the actuating element, is deformed and thus displaces the locking elements.

It was very surprising and unexpected for the person skilled in the art that the locking and unlocking device according to the invention could be reliably produced using very few parts. The locking and unlocking device may be produced and may be actuated easily and cost-effectively.

The locking and unlocking device according to the invention is suitable for any part in a motor vehicle which has to be locked and unlocked. In particular, hinged lids may be reversibly closed by means of the locking and unlocking device. These hinged lids, for example, may be the hinged lid of a glove compartment or the like.

According to the invention, the locking and unlocking device comprises at least one, preferably two, displaceably mounted locking elements. This locking element is, for example, fastened to the hinged lid to be locked, and cooperates in the locked state with the vehicle interior trim and/or the bodywork. It is, however, also possible to arrange the locking elements on the bodywork and/or the interior trim of the motor vehicle.

Moreover, the locking and unlocking device comprises an actuating element, by means of which the locking element is actuated. This locking element may be a slide or the like. Preferably the actuating element, however, is a pushbutton.

Moreover, according to the invention the locking and unlocking device comprises a deformation element which, when actuating an actuating element, is deformed and thus displaces the locking elements. Deformed within the meaning of the invention is a change in shape of any kind.

Preferably the deformation element is a leaf spring or a leg spring.

Further preferably, at least one end of the spring is preferably displaceably mounted on the locking element. As a result of this mounting, when the spring changes shape, the locking element is moved.

Preferably, the locking and unlocking device comprises guide means along which the deformation means is deformed.

### DRAWINGS

The invention is described hereinafter with reference to FIGS. 1 and 2. These explanations are provided merely by way of example and do not restrict the general inventive idea.

FIG. 1 shows an embodiment of the locking and unlocking device in the locked state and

FIG. 2 shows the locking and unlocking device according to FIG. 1 in the unlocked state.

### DETAILED DESCRIPTION

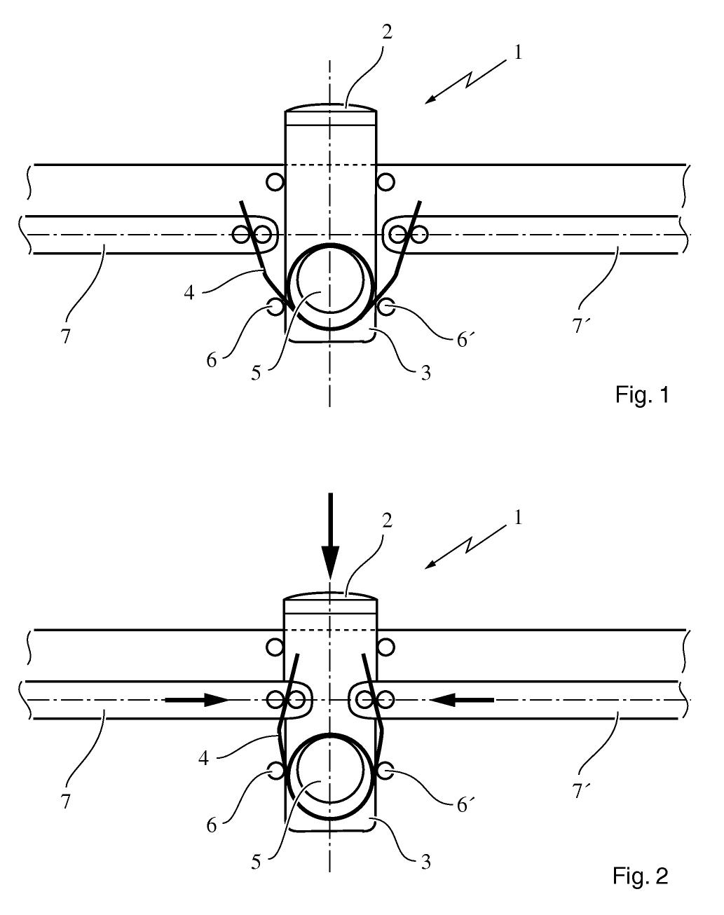

The locking and unlocking device 1 according to the invention is shown in FIG. 1. In the present case the locking and unlocking device is that of a glove compartment or the like, which may be actuated by means of a pushbutton 2. This pushbutton 2 has an inwardly projecting bolt 3 on which a pin 5 projecting at right angles is arranged. This pin 5 is at least partially encompassed by a leg spring 4, the two ends thereof respectively being displaceably connected in the form of a movable bearing to one respective push rod 7, 7′. The push rods 7, 7′ are, in turn, horizontally displaceably mounted and effect the locking and/or unlocking of the hinged lid of the glove compartment. Moreover, the device according to the invention comprises guide means 6, 6′, in the present case mandrels, which stabilize the leg spring in its position and, as will be described in more detail below, channel the deformation of the leg spring.

The unlocking of the locking and unlocking device according to the invention is shown in FIG. 2. As symbolized by the vertical arrow, the pushbutton is pressed downward. At the same time, the pin 5 drives the leg spring and by means of the guide means 6, 6′ the limbs of the spring are bent together. This movement of the leg spring is, as symbolized by the two horizontal arrows, transmitted to the push rods 7, 7′, which as a result are pulled together, which causes the unlocking of the hinged lid of the glove compartment. As soon as the pushbutton is released, the spring 4 presses the pin 5 and thus the bolt 3 upward and the leg spring 4 is relaxed into the position shown in FIG. 1. This movement of the spring is transmitted to the push rods 7, 7′, which as a result are forced into the locking position. The push rods may spring into the respective fastening independently of one another and again latch the glove compartment.

Not only the return of the pushbutton but also the movement of the push rods 7, 7′ is effected by means of the leg spring 4, which considerably reduces the parts required.

1. A locking and unlocking device comprising at least one displaceably mounted locking element;
an actuating element which actuates the locking element; and
a deformation element which, is deformed when the actuating element is actuated and thus displaces the locking elements.

2. The locking and unlocking device as claimed in claim 1, wherein the deformation element is a leaf spring or a leg spring.

3. The locking and unlocking device as claimed in claim 2, wherein at least one end of the spring is preferably displaceably mounted on the locking element.

4. The locking and unlocking device as claimed in claim 1, comprising guide means along which the deformation element is deformed.

5. The locking and unlocking device as claimed in claim 1, wherein the actuating element is a pushbutton.
